(19) United States
(12) Patent Application Publication
(10) Pub. No.: US 2025/0112319 A1
(43) Pub. Date: Apr. 3, 2025

(54) BATTERY SYSTEM HAVING IMPROVED COVER PLATE

(71) Applicant: SAMSUNG SDI CO., LTD., Yongin-si (KR)

(72) Inventor: Andreas Pröll, Helfenberg (AT)

(21) Appl. No.: 18/756,995

(22) Filed: Jun. 27, 2024

(30) Foreign Application Priority Data
Sep. 28, 2023 (EP) 23200590.0

(51) Int. Cl. H01M 50/342; H01M 10/658; H01M 50/198; H01M 50/249; H01M 50/264; H01M 50/276; H01M 50/586

(52) U.S. Cl. CPC H01M 50/3425; H01M 10/658; H01M 50/198; H01M 50/249; H01M 50/264; H01M 50/276; H01M 50/586

(57) ABSTRACT

A battery system for an electric vehicle includes: a plurality of battery cells, each of the battery cells having a venting side with a venting exit for allowing a venting gas stream to exit the battery cells; a housing accommodating the battery cells; a cover plate covering the battery cells at the venting sides to protect the battery cells from venting products in the venting gas stream, the cover plate having venting openings respectively aligned with the venting exits for allowing the venting gas stream pass through the cover plate; a thermally insulating sealing layer between the cover plate and the venting sides of the battery cells, the sealing layer extending around the venting exits; and a mounting component fixing the cover plate to the housing such that the cover plate exerts a compression force onto the sealing layer.

### CROSS-REFERENCE-TO RELATED APPLICATION

The present application claims priority to and the benefit of European Patent Application Ser. No. 23/200,590.0, filed on Sep. 28, 2023, in the European Patent Office, the entire disclosure of which is incorporated herein by reference.

### BACKGROUND

### 1. Field

Aspects of embodiments of the present disclosure relate to a battery system having an improved cover plate.

### 2. Description of the Related Art

In recent years, vehicles for transportation of goods and people have been developed that use electric power as a source for motion. Such an electric vehicle is an automobile that is propelled by an electric motor, using energy stored in rechargeable batteries. An electric vehicle may be solely powered by batteries or may be a hybrid vehicle powered in part by, for example, a gasoline generator or a hydrogen fuel cell. Furthermore, the hybrid vehicle may include a combination of an electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power over sustained periods of time. A rechargeable (or secondary) battery differs from a primary battery in that it is designed to be repeatedly charged and discharged, while the latter is designed to provide only an irreversible conversion of chemical to electrical energy. Low-capacity rechargeable batteries may be used as a power supply for small electronic devices, such as cellular phones, notebook computers, and camcorders, while high-capacity rechargeable batteries may be used as power supplies for electric and hybrid vehicles and the like.

Generally, rechargeable batteries include an electrode assembly including a positive electrode, a negative electrode, and a separator interposed between the positive and negative electrodes, a case for receiving (or accommodating) the electrode assembly, and an electrode terminal electrically connected to the electrode assembly. An electrolyte solution is injected into the case to enable charging and discharging of the battery through an electrochemical reaction between the positive electrode, the negative electrode, and the electrolyte solution. The shape of the case, such as cylindrical or rectangular, depends on the battery's intended purpose. Lithium-ion (and similar lithium polymer) batteries, widely known via their use in laptops and consumer electronics, dominate the most recent electric vehicles in development.

Rechargeable batteries may be used as (or as part of) a battery module including of a plurality of unit battery cells coupled to each other in series and/or in parallel to provide a high energy density, in particular for motor driving of a hybrid vehicle. For example, the battery module may be formed by interconnecting the electrode terminals of the plurality of unit battery cells in an arrangement based on a desired amount of power and to provide a high-power rechargeable battery.

Battery modules can be constructed in either a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include of a plurality of battery modules connected to each other in series to provide a desired voltage. Therein, the battery modules may include submodules with a plurality of stacked battery cells, and each stack includes cells connected to each other in parallel that are, in turn, connected in series (XpYs) or cells connected to each other in series that are, in turn, connected in parallel (XsYp).

A battery pack is a set of any number of battery modules. Generally, the battery modules in a battery pack are identical. The battery modules may be configured in (e.g., may be connected together in) series, parallel, or a mixture of both to provide the desired voltage, capacity, and/or power density. Components of a battery pack include the individual battery modules and interconnects, which provide electrical conductivity between the battery modules.

To provide thermal control of the battery cells within the battery housing, a thermal management system may be used to efficiently emit, discharge, and/or dissipate heat generated within the battery housing. If the heat emission, discharge, and/or dissipation is not sufficiently performed, temperature deviations may occur between respective battery cells, such that the at least one battery module may no longer generate a desired (or designed) amount of power. In addition, an increase of the internal temperature can lead to abnormal reactions occurring in the battery cells. Hence, the charging and discharging performance of the rechargeable battery deteriorates and the lifespan of the rechargeable battery is shortened. Thus, battery cell cooling for effectively emitting, discharging, and/or dissipating heat from the battery cells is important.

Exothermic decomposition of cell components may lead to a so-called thermal runaway. Thermal runaway is a self-accelerating chemical reaction inside the battery cell, which produces high amounts of heat and venting gas, until nearly all available material is exhausted. The exhausted material, that is, the venting products, may include hot and toxic venting gas as well as potentially conductive solid material, like graphite powder and metal fragments. In rechargeable battery systems, the thermal runaway is associated with strong exothermic reactions that are accelerated by a rise in temperature. These exothermic reactions include combustion of flammable gas compositions within the battery pack housing. For example, when a battery cell is heated above a critical temperature (typically above about 150° C.) the battery cell can transition into a thermal runaway. The initial heating may be caused by a local failure, such as a battery cell having an internal short circuit, heating from a defective electrical contact, and/or a short circuit to a neighboring battery cell. During the thermal runaway, a failed battery cell, that is, a battery cell having a local failure, may reach temperatures exceeding about 700° C. Further, large quantities of hot gas are ejected from inside of the failed battery cell through the venting opening in the cell housing into the battery pack. The main components of the vented gas are H₂, CO₂, CO, electrolyte vapor, and other hydrocarbons. Moreover, the vented gas is flammable and potentially toxic. The vented gas may also cause a gas-pressure to increase inside the battery pack.

A related-art venting concept for a battery is to let the venting gas stream, including hot venting gases and particles exiting the battery cell(s), expand into the battery housing and escape through a housing venting valve to the outside (for example, to the environment of the battery housing). The venting gas stream heats up the battery housing and the components inside the battery housing, and the particles may deposit onto the battery cells. To protect the battery cells from this, a cover element may be provided, covering the battery cells at their venting side.

The cover element may include, for example, a non-conductive polymer or a mineral plate. However, such materials may not withstand the high temperatures and pressures during thermal runaway and may mechanically disintegrate. In such a case, the venting gas stream may reach the other battery cells and transfer a significant amount of thermal energy to the battery cells which it comes into contact with, thereby damaging the cells and possibly contributing to a thermal propagation of the runaway event to the remaining cells. Furthermore, the particles of the venting gas stream may contaminate the internal components of the battery pack, leading to conductive paths between metallic parts with different electrical potential (for example, the housing and electrical connecting components, such as busbars). This can lead to formation of arcs, which further accelerates the thermal propagation of a thermal runaway event to the remaining cells.

### SUMMARY

Embodiments of the present disclosure overcome or mitigate at least some of the drawbacks of the prior art and provide a battery system that more securely handles a thermal runaway of one or more of its battery cells without damaging components of the battery system.

The present disclosure is defined by the appended claims and their equivalents. The description that follows is subject to this limitation. Any disclosure lying outside the scope of the claims is intended for illustrative as well as comparative purposes.

According to an embodiment of the present disclosure, a battery system for an electric vehicle includes: a plurality of battery cells, each of the battery cells having a venting side with a venting exit for allowing a venting gas stream to exit the battery cells; a housing accommodating the battery cells; a cover plate covering the battery cells at the venting sides to protect the battery cells from venting products in the venting gas stream, the cover plate having venting openings respectively aligned with the venting exits for allowing the venting gas stream pass through the cover plate; a thermally insulating sealing layer between the cover plate and the venting side of the battery cells, the sealing layer extending around the venting exits; and a mounting component fixing the cover plate to the housing such that the cover plate exerts a compression force onto the sealing layer.

According to an embodiment of the present disclosure, the cover plate may include metal.

According to an embodiment of the present disclosure, the cover plate may include steel.

According to an embodiment of the present disclosure, the cover plate may have a bent portion bent towards the battery cells.

According to an embodiment of the present disclosure, the bent portion may have a trapezoidal shape.

According to an embodiment of the present disclosure, the cover plate may entirely cover the venting sides of the battery cells.

According to an embodiment of the present disclosure, the battery cells may be interconnected with one another via electrical connecting components contacting electrode terminals of the battery cells, and the cover plate may cover the electrode terminals and electrical connecting components such that the electrode terminals and electrical connecting components are shielded from venting products exiting the venting exit of one or more of the battery cells in case of a thermal runaway.

According to an embodiment of the present disclosure, the battery system may further include an insulation layer between the cover plate and the electrical connecting components.

According to an embodiment of the present disclosure, the insulation layer may include a ceramic felt layer.

According to an embodiment of the present disclosure, the sealing layer may include a ceramic fiber plate.

According to an embodiment of the present disclosure, the cover plate may have impressions extending around the venting openings.

According to an embodiment of the present disclosure, the venting openings in the cover plate may be sealed with a temperature-resistant diaphragm.

According to an embodiment of the present disclosure, the cover plate may have a spherical indentation indented towards the sealing layer, and the spherical indentation may extend around at least one of the venting openings.

According to an embodiment of the present disclosure, one or more of the venting openings in the cover plate may be surrounded, in a plan view, by an inclined outer surface of the cover plate, and the inclined outer surface may be inclined towards the one or more of the venting openings.

According to another embodiment of the present disclosure, an electric vehicle may include a battery system as defined above.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments with reference to the attached drawings, in which:

FIG. 1 is a schematic perspective view of a battery system according to an embodiment.

FIG. 2 is a schematic cross-sectional view of the battery system shown in FIG. 1.

FIGS. 3A and 3B illustrate a venting opening of a cover plate of the battery system shown in FIG. 1 according to various embodiments.

### DETAILED DESCRIPTION

Reference will now be made, in detail, to embodiments, examples of which are illustrated in the accompanying drawing. Aspects and features of the embodiments, and implementation methods thereof, will be described with reference to the accompanying drawing. The present disclosure, however, may be embodied in various different forms and should not be construed as being limited to the illustrated embodiments. Rather, these embodiments are provided as examples so that this disclosure will be thorough and complete and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawing, the relative sizes of elements, layers, and regions may be exaggerated for clarity. For example, in the drawings, the size or thickness of each element may be arbitrarily shown for illustrative purposes, and thus the embodiments of the present disclosure should not be construed as being limited thereto.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure. Expressions such as “at least one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

As used herein, the term “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

It will also be understood that when a film, a region, or an element is referred to as being “above” or “on” another film, region, or element, it can be directly on the other film, region, or element, or intervening films, regions, or elements may also be present.

Herein, the terms “upper” or “top” and “lower” or “bottom” are defined according to the z-axis. These terms may, in particular, refer to the intended installation of the battery system inside an electric vehicle.

In the following description of embodiments of the present disclosure, the terms of a singular form may include plural forms unless the context clearly indicates otherwise.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification and should not be interpreted in an idealized or overly formal sense, unless expressly so defined herein.

According to an embodiment of the present disclosure, a battery system is provided. The battery system includes a housing that accommodates a plurality of battery cells, forming a battery housing. The battery cells may be interconnected through electrical connecting components, for example, busbars, contacting the respective electrode terminals of the battery cells to form one or more battery modules/battery packs. The battery cells are arranged to form one or more battery packs, in which the battery cells are electrically interconnected, for example, in series and/or in parallel, as explained above. Multiple battery packs may form a battery module. Two or more of the battery packs may be stacked to form cell stacks.

The battery cells may be, for example, prismatic or cylindrical cells. Each of the battery cells has a venting exit at a venting side of the battery cell, which may be the terminal side of the battery cells. The venting exits allows a venting gas stream to escape (or exit) the battery cells during a thermal runaway. Venting valves may be provided at (or in) the venting exits.

The battery system may further include a cover plate covering at least part of the venting side of the battery cells. The cover plate may cover multiple battery cells at their venting side. The cover plate may be configured to cover all of the battery cells of a battery pack. Also, the cover plate may be configured to cover the battery cells of multiple cell stacks and, thus, may provide a one-piece solution for covering the battery cells. The cover plate covers the venting side around the venting exits. The cover plate has venting openings in the form of through-holes, and the venting openings are each aligned with a respective one of the venting exits of the battery cells so that the venting gas stream exiting one of the battery cells through its venting exit may pass through the corresponding venting opening. The cover plate is mechanically rigid. For example, the cover plate is stiff, at least with respect to forces commonly experienced during a thermal runaway of one or more of the battery cells. For example, the cover plate is mechanically rigid such that it may withstand forces commonly experienced during a thermal runaway of one or more of the battery cells without substantially bending, without breaking, and/or such that the cover plate may remain structurally integrated with the housing to which it is fixed. This rigidity can be achieved by a suitable choice of material (for example, steel), a material's thickness, and/or the shape of the cover plate, which is explained in further detail below. The cover plate covers the plurality of battery cells at their venting sides whereby the cover plate protects the covered battery cells from depositing venting products of the venting gas stream. The cover plate is configured to withstand temperatures usually occurring during a thermal runaway, for example, temperatures of at least about 700° C. to at least about 1000° C.

A thermally insulating sealing layer is disposed between the cover plate and the venting side of the battery cells. The sealing layer provides a seal between the battery cells and the cover plate to prevent the venting gas stream from flowing in-between the battery cells and the cover plate and to prevent heat transfer from the cover plate to the battery cells. The sealing layer surrounds (for example, extends around a periphery of) the venting exits of the battery cells. The sealing layer may also surround the venting openings of the cover plate, which are arranged on the other side of the sealing layer. The sealing layer includes a high temperature sealing material, for example, a ceramic fiber plate. The sealing layer is configured to withstand the temperatures usually occurring during a thermal runaway, that is, temperatures of at least about 700° C. to at least about 1000° C.

According to one or more embodiments of the present disclosure, the cover plate exerts a compression (or compressive) force onto the sealing layer. For example, the cover plate is configured to exert or apply the compression force onto the sealing layer. The compression force compresses the sealing layer, at least to some degree. For example, the sealing layer may be compressible to an extent such that a sufficient sealing is achieved by the cover plate applying the compression force to the sealing layer. To this end, the battery system may include a mounting component that affixes the cover plate to the housing of the battery system. The housing acts as a counter bearing for the mounting component/cover plate. The mounting component may clamp or press the cover plate against the sealing layer with a respective counter force being provided by the housing (that is, the structural part of the housing to which the mounting component is attached). The compression force may also be considered a clamping force. The compression force exerted by the cover plate is sufficiently high to maintain the sealing provided by the sealing layer throughout the entire duration of a thermal runaway of one or more of the battery cells. For example, a minimum compression force is maintained that is sufficient to seal the cover plate to the battery cells throughout the entire duration of the thermal runaway. Because the cover plate is mechanically rigid, it is suited and configured to exert the compression force onto the sealing layer, that is, to transfer the compression force from the mounting component to the sealing layer. For example, the cover plate may be configured to exert the compression force onto the entire area of the sealing layer and not only onto an area near the mounting points where the mounting component contacts the cover plate. For example, the mechanically rigid cover plate is configured to transfer the force applied by the mounting component to the cover plate onto the entire sealing layer.

Accordingly, the cover plate and the sealing provided by the sealing layer may withstand the temperatures and pressures that may build up (e.g., may occur) during a thermal runaway of one or more of the battery cells. Because the cover plate is mechanically rigid and pressed and/or clamped against the sealing layer, the counterforces usually occurring during the thermal runaway do not exceed the compression force. Rather, at least a minimum force applied from the cover plate to the sealing layer remains even during thermal runaway. Therefore, the cover plate, the sealing layer and, thus, the sealing, will not mechanically disintegrate during thermal runaway. The venting gas stream is, thus, prevented from reaching the other battery cells, thereby hindering thermal propagation of the runaway event to the remaining cells. Further, the particles of the venting gas stream deposit onto the outer surface of the cover plate so that the battery cells and the sealing layer are shielded from them. While such a deposit may heat up the cover plate, the sealing layer being thermally insulating prevents, or at least reduces, heat transfer from the cover plate to the battery cells, thus protecting the battery cells.

According to some embodiments, the cover plate is made of metal. For example, the cover plate may be made of steel, may be a metal plate, or may be a steel plate. Metal (for example, steel) is suited for providing the cover plate with stiffness and, thus, provides a mechanically rigid cover plate. The material thickness and/or shape of the cover plate may be chosen based on the material whereby the cover plate is mechanically rigid enough to withstand the above-explained forces during a thermal runaway. According to some embodiments, the cover plate may be a bi-metallic plate, for example, a steel alloy.

According to some embodiments, the cover plate has a bent portion that is bent towards the battery cells, that is, towards the venting side of the battery cells. The bent portion is bent towards the battery cells to maintain the compression force exerted uniformly to the sealing layer over the entire area of the sealing layer. The bent portion extends farther towards the venting side of the battery cells than the adjacent portion of the cover plate, which is adjacent to the bent portion. The bent portion may form an indentation or trench in the cover plate with a base thereof contacting the sealing layer. The bent portion is formed into the cover plate during manufacturing of the cover plate and, thus, may be considered a pre-bent portion. The bent portion may be arranged at an area of the cover plate between the mounting points where the mounting components contact the cover plate, for example, in the middle between two mounting components. Thus, the bent portion of the cover plate is bent towards the battery cells between the mounting positions of a first and second mounting component. The bent portion ensures uniform compression of the sealing layer over the entire area of the sealing layer. For example, the bent portion allows the cover plate to exert or transfer the compression force onto the sealing layer throughout its entire length and/or area. Without such a bent portion, the cover plate may only exert a sufficient compression force to the battery cells or parts of battery cells near to the mounting components. Thus, the outer battery cells or only the outer edges of the sealing layer in the transverse direction would have a sufficient sealing. With the cover plate having the bent portion, sufficient sealing during thermal runway is maintained over the entire extension of the sealing layer.

According to some embodiments, the bent portion has a trapezoidal shape. For example, the bent portion forms a trapezoidal indentation towards the battery cells with a base thereof contacting the sealing layer. The trapezoid shape of the bent portion has a base and two legs interconnected by the base. The legs are inclined inversely and relative to a vertical axis form undercuts with respect to the adjacent portions of the cover plate. For example, a width of the indentation or trench formed by the bent portion is larger nearer to the battery cells and smaller farther away from the battery cells. The bent portion having such a trapezoidal shape ensures that the compression force is exerted uniformly to the sealing layer over the entire area of the sealing layer.

According to some embodiments, the cover plate fully covers the venting sides of the battery cells. For example, the cover plate extends along the entire/complete venting side of the battery cells. The cover plate may fully (or entirely) cover the battery cells at an upper or lower side thereof. For example, the cover plate fully covers the venting sides of the battery cells side, aside from the venting openings, so that a venting gas stream leaving one or more of the battery cells through their respective venting exits may still pass through the cover plate. The cover plate fully covering the battery cells shields (e.g., protects) the battery cells from the venting gas stream, preventing venting products, such as particles, from depositing onto the battery cells. The cover plate may also cover the electrical connecting components interconnecting the battery cells.

According to some embodiments, the battery cells are interconnected through electrical connecting components contacting electrode terminals of the battery cells. The cover plate shields the electrode terminals and electrical connecting components from venting products exiting the venting exit of one or more of the battery cells as the venting products deposit onto the cover plate in case of a thermal runaway. The electrical connecting components may, for example, be busbars connecting the electrode terminals of the battery cells, as explained above. According to some embodiments, the cover plate also shields the electrode terminals and the electrical connecting components, protecting them from the venting gas stream and, in particular, from venting products that would otherwise deposit onto the terminals and connecting components in case of a thermal runaway. This prevents damage to the terminals and connecting components. Moreover, this prevents short-circuits or arcing between the connecting components that may otherwise lead to further damage.

According to some embodiments, the battery system further includes an insulation layer arranged between the cover plate and the electrical connecting components. The insulation layer may be an electrically and/or thermally insulating insulation layer. One or more of such insulation layers may be provided, for example, for each electrical connecting component. For instance, both the connecting component connecting to the two electrode terminals may be provided with such an insulation layer. In some embodiments, the cover plate covers the electrode terminals and electrical connecting components with the insulation layer provided in between. The insulation layer may extend along one or more sides of the connecting components. Also, the insulation layer may extend along the sides of the electrode terminals. The insulation layer may extend from the electrical connecting components and electrode terminals onto the venting side, that is, towards the venting side of the battery cells and contacting the venting side. The insulation layer may include one or more of a ceramic felt layer, a ceramic fiber fleece, a needle mat, or expanded polymeric materials. These are suited for electrical/thermal insulation of the electrode terminals and electrical connecting components. The insulation layer, according to some embodiments, protects the electrode terminals and electrical connecting components from heat transfer or electrical conduction from the cover plate, which may otherwise occur due to venting products depositing onto the cover plate. Further, when extending onto the venting side, such insulation layer may prevent contamination of the terminals and connecting components by venting gas, should such venting gas leak through the compressed sealing layer. The cover plate, fixed to the housing of the battery system via the mounting components, may also exert a compression force onto the insulation layer, thereby maintaining the insulation of the electrode terminals and electrical connecting components, in particular, during a thermal runaway.

According to some embodiments, the sealing layer includes a ceramic fiber plate, in which ceramic fibers may be embedded in a matrix, such as a resin. The ceramic fiber plate is suited for thermal insulation and withstanding the high temperatures occurring during a thermal runaway. Further, the ceramic fiber plate is compressible enough to achieve the sealing described above and can withstand the pressure and temperature of the thermal runaway.

According to some embodiments, the cover plate includes impressions, for example, rim-like impressions, around the venting openings. Such impressions may increase the compression force on the sealing layer.

According to some embodiments, the venting openings of the cover plate are sealed with a temperature-resistant diaphragm. The diaphragm may be, for example, a mica sheet, that is, a sheet of mica silicate minerals. Such a diaphragm seals the venting openings and, thus, prevents any outside contamination, for example, moisture or other particles from entering the battery cells through their venting exits during normal operation. The diaphragm is configured to rupture (e.g., burst) during a thermal runaway event. For example, a venting gas stream exiting the venting exit of one or more of the battery cells will rupture the diaphragm, thus allowing the venting gas stream pass through the venting opening and therefore through the cover plate.

According to some embodiments, one or more of the venting openings of the cover plate are respectively surrounded (e.g., surrounded in a plan view) by an inclined outer surface of the cover plate, and the inclined outer surface may be inclined towards the venting opening. That is, the outer surface of the cover plate surrounding the venting opening may be tapered or may be funnel-shaped towards the venting opening. Thus, a cross-section of the venting opening may widen when viewed along a venting direction. This may allow for an improved venting of the venting gas stream exiting through the venting opening because the venting gas stream may rapidly expand to all sides due to the widening cross section.

According to some embodiments, the cover plate includes at least one spherical indentation, which is indented towards the sealing layer. The spherical indentation has at least one of the venting openings. For example, one or more of the venting openings of the cover plate may be arranged at the bottom of a respective spherical indentation in the cover plate. That is, the spherical indentation may form a concave portion of the cover plate and may have the venting opening. For each of the venting openings, one of such spherical indentations may be provided. The spherical indentation being indented towards the sealing layer locally increases the contact pressure on the sealing layer around the venting exit of the battery cell and, therefore, further improves the sealing.

Embodiments of the present disclosure also pertain to an electric vehicle including a battery system as described above.

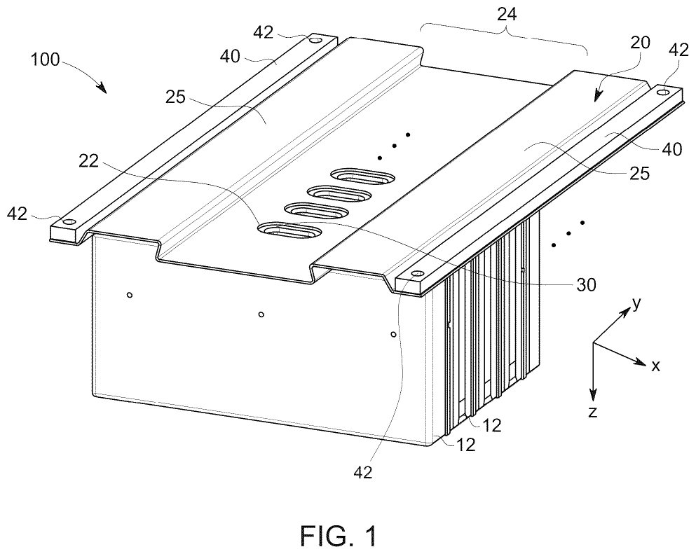

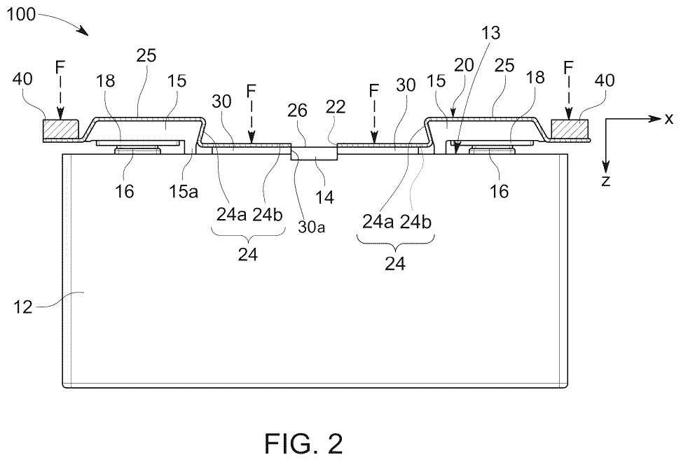

FIGS. 1 and 2 schematically illustrate a battery system 100 according to an embodiment of the present disclosure. The battery system 100 includes a battery housing accommodating a plurality of battery cells 12. For illustration purposes, only four battery cells 12 are shown, with reference numerals provided for only two of them.

Each of the battery cells 12 includes two electrode terminals 16, which are interconnected with the electrode terminals 16 of neighboring battery cells 12 via electrical connecting components 18, such as busbars (see, e.g., FIG. 2). The battery cells 12 are thus arranged to form one or more battery packs. Each of the battery cells 12 has a venting side 13 with a venting exit 14 for allowing a venting gas stream to exit the battery cells 12 in case of a thermal runaway occurring inside the respective battery cell 12.

The battery system 100 further includes a mechanically rigid cover plate 20 fully (or entirely) covering the plurality of battery cells 12 at their venting sides 13, that is, the cover plate 20 sufficiently extends along an x-axis and along a y-axis (see, e.g., FIG. 1) such that it entirely covers the plurality of battery cells 12. The cover plate 20 has protruding portions 25 that respectively extend above and cover the electrode terminals 16 and the electrical connecting components 18 (see, e.g., FIG. 2). The cover plate 20 has venting openings 22 that are respectively aligned with the venting exits 14 for allowing the venting gas stream to pass through the cover plate 20. Thus, the cover plate 20 entirely covers the battery cells 12 at their venting sides 13, aside from the venting exits 14, because the venting exits 14 are aligned with the venting openings 22 in the cover plate 20. Hence, a venting gas stream exiting one or more of the battery cells 12 through their venting exits 14 during a thermal runaway may pass through the corresponding venting openings 22 to the outer side of the cover plate 20. Further, the cover plate 20 has a bent portion 24 having a trapezoidal shape.

The bent portion 24 has two legs 24a that are interconnected by a base 24b. Below the base 24b, a thermally insulating sealing layer 30 is arranged on top of the battery cells 12 and, thus, between the cover plate 20 and the venting side 13 of the battery cells 12. The sealing layer 30 surrounds (e.g., extends around a periphery of) the venting exits 14. That is, the sealing layer 30 has openings 30a through which the venting gas stream leaving the venting exits 14 may pass.

Mounting components 40 are attached to the cover plate 20 at opposite ends thereof at mounting points 42. The mounting components 40 affix to the cover plate 20 to the housing of the battery system 100 by pressing or clamping the cover plate 20 onto the housing such that the cover plate 20 exerts a compression force F (indicated by dashed arrows in FIG. 2) onto the sealing layer 30. For example, the housing acts as a counter bearing component for the mounting components 40 so that the mounting components may exert a force onto the cover plate 20, and the cover plate 20 may in turn exert a compression force onto the sealing layer 30. The cover plate 20, therefore, compresses the sealing layer 30, which, for example, may be a ceramic fiber plate.

This improves the sealing, preventing the venting gas stream from entering between the cover plate 20 and the venting side 13 of the battery cells 12. Further, the sealing layer 30 thermally insulates the battery cells 12 from the cover plate 20, thereby preventing or reducing heat transfer from the cover plate 20 to the venting side 13. The battery cells 12 are thus shielded from any venting products depositing onto the cover plate 20 without heat being transferred from the cover plate 20, which is heated-up by the venting products. Because the cover plate 20 is mechanically rigid and pressed (or clamped) against the sealing layer 30 by the mounting components 40, even the counterforces occurring during a thermal runaway do not exceed the compression force. The bent portion 24 allows the cover plate 20 to exert uniform compression force onto the entire area of the sealing layer 30 and not only near the mounting components 40. For example, due to the shape of the cover plate 20, the cover plate 20 may effectively and uniformly transfer the force received via the mounting components 40 to the sealing layer 30.

As a result, the cover plate 20 and, thus, the sealing provided by the sealing layer 30, may withstand the temperatures and pressures that may build up during a thermal runaway of one or more of the battery cells 12. Therefore, the cover plate 20, the sealing layer 30, and thus the sealing, will withstand the thermal runaway. The venting gas stream is thus prevented from reaching the other battery cells 12 and thermal propagation of the runaway event is preventing from reaching or affecting the remaining cells. Further, particles from the venting gas stream deposit onto the outer surface of the cover plate 20, shielding the battery cells 12 and the sealing layer 30 from them. Although such a deposit may heat up the cover plate 20, the sealing layer 30, being thermally insulating, prevents or at least reduces heat transfer from the cover plate 20 to the battery cells 12, thereby protecting the battery cells 12.

The battery system 100 further includes insulation layers 15 arranged between the cover plate 20 at its protruding portions 25 and the electrical connecting components 18. The insulation layer 15 is an electrically and thermally insulating insulation layer. As shown in FIG. 2, the insulation layers 15 extends with an extension portion 15a along the inner sides of the connecting components 18 and electrode terminals 16 onto the venting sides 13. The insulation layers 15 protect the electrode terminals 16 and electrical connecting components 18 from heat transfer and electrical conduction with the cover plate 20. Further, because the extension portions 15a extend onto the venting side 13, the insulation layers 15 prevent contamination of the electrode terminals 16 and connecting components 18 by venting gas, should such venting gas leak through the compressed sealing layer 30.

Further, the cover plate 20 exerts a compression force via its protruding portions 25 onto the insulations layer 15, thereby maintaining insulation for the electrode terminals 16 and electrical connecting components 18, even during a thermal runaway.

The venting openings 22 in the cover plate 20 are each sealed with a temperature-resistant diaphragm 26, preventing any outside contamination, such as moisture or other particles, from entering the battery cells 12 through their venting exits 14 during normal operation. The diaphragm 26 is configured to rupture during a thermal runaway event. In other words, a venting gas stream exiting the venting exit 14 of one or more of the battery cells 12 will rupture the diaphragm 26 and thus pass through the venting opening 22 and, therefore, through the cover plate 20.

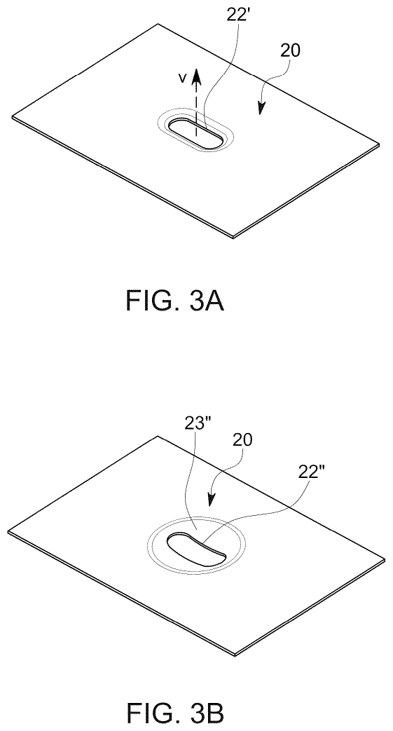

FIGS. 3A and 3B show the venting openings 22′ and 22″ in the cover plate 20 according to various embodiments. In FIGS. 3A and 3b, the cover plate 20 is shown in part, such that only one venting opening 22′ or 22″ are visible.

In the embodiment shown in FIG. 3A, the outer surface of the cover plate 20 surrounding (e.g., extending around a periphery of) the venting opening 22′ is inclined towards the venting opening 22′. For example, the outer surface of the cover plate 20 surrounding the venting opening 22′ is tapered or funnel-shaped towards the venting opening 22′. Thus, a cross-section of the venting opening 22′ widens when viewed along a venting direction V. This may allow for improved venting of the venting gas stream exiting through the venting opening 22′ because the venting gas stream may rapidly expand to all sides due to the widening cross-section.

In the embodiment shown in FIG. 3B, the cover plate 20 has a spherical indentation 23″, which is indented towards the sealing layer 30, and the spherical indentation 23″ has the venting opening 22″. For example, the venting opening 22″ in the cover plate 20 is arranged at the bottom of the spherical indentation 23″. That is, the spherical indentation 23″ forms a concave portion of the cover plate 20 and has the venting opening 22″. This embodiment, due to the spherical indentation 23″ being indented towards the sealing layer 30, locally increases the contact pressure on the sealing layer 30 around the venting exit 14 of the battery cell 12 and, therefore, further improves the sealing.

### SOME REFERENCE SYMBOLS

12 battery cells
13 venting sides
14 venting exits
15 insulation layers
15a extension portions of insulation layers
16 electrode terminals
18 electrical connecting component
20 cover plate
22 venting openings
22′ venting opening
22″ venting opening
23″ spherical indentation including venting opening
24 bent portion of cover plate
24a legs of bent portion
24b base of bent portion
25 protruding portion
26 diaphragm
30 sealing layer
40 mounting component
42 mounting points
100 battery system
V venting direction

What is claimed is:

1. A battery system for an electric vehicle, the battery system comprising
a plurality of battery cells, each of the battery cells having a venting side with a venting exit for allowing a venting gas stream to exit the battery cells;
a housing accommodating the battery cells;
a cover plate covering the battery cells at the venting sides to protect the battery cells from venting products in the venting gas stream, the cover plate having venting openings respectively aligned with the venting exits for allowing the venting gas stream pass through the cover plate;
a thermally insulating sealing layer between the cover plate and the venting sides of the battery cells, the sealing layer extending around the venting exits; and
a mounting component fixing the cover plate to the housing such that the cover plate exerts a compression force onto the sealing layer.

2. The battery system as claimed in claim 1, wherein the cover plate comprises metal.

3. The battery system as claimed in claim 2, wherein the cover plate comprises steel.

4. The battery system as claimed in claim 1, wherein the cover plate has a bent portion bent towards the battery cells.

5. The battery system as claimed in claim 4, wherein the bent portion has a trapezoidal shape.

6. The battery system as claimed in claim 1, wherein the cover plate entirely covers the venting sides of the battery cells.

7. The battery system as claimed in claim 1, wherein the battery cells are interconnected with one another via electrical connecting components contacting electrode terminals of the battery cells, and
wherein the cover plate covers the electrode terminals and electrical connecting components such that the electrode terminals and electrical connecting components are shielded from venting products exiting the venting exit of one or more of the battery cells in case of a thermal runaway.

8. The battery system as claimed in claim 7, further comprising an insulation layer between the cover plate and the electrical connecting components.

9. The battery system as claimed in claim 8, the insulation layer comprises a ceramic felt layer.

10. The battery system as claimed in claim 1, wherein the sealing layer comprises a ceramic fiber plate.

11. The battery system as claimed in claim 1, wherein the cover plate comprises impressions extending around the venting openings.

12. The battery system as claimed in claim 1, wherein the venting openings in the cover plate are sealed with a temperature-resistant diaphragm.

13. The battery system as claimed in claim 1, wherein the cover plate has a spherical indentation indented towards the sealing layer, and
wherein the spherical indentation extends around at least one of the venting openings.

14. The battery system as claimed in claim 1, wherein one or more of the venting openings in the cover plate are surrounded in a plan view by an inclined outer surface of the cover plate, and
wherein the inclined outer surface is inclined towards the one or more of the venting openings.

15. An electric vehicle comprising the battery system as claimed in claim 1.
